(19) United States
(12) Patent Application Publication
(10) Pub. No.: US 2017/0010866 A1
(43) Pub. Date: Jan. 12, 2017

(54) METHOD, DEVICE AND NON-TRANSITORY COMPUTER-READABLE MEDIUM FOR CRYPTOGRAPHIC COMPUTATION

(71) Applicant: Winbond Electronics Corp., Taichung City (TW)

(72) Inventor: Uri Kaluzhny, Taichung City (TW)

(21) Appl. No.: 15/016,293

(22) Filed: Feb. 5, 2016

(30) Foreign Application Priority Data
Jul. 9, 2015 (IL) 239880

(51) Int. Cl. G06F 7/72; G06F 21/60

(52) U.S. Cl. CPC G06F 7/728; G06F 21/602

(57) ABSTRACT

A method, a device and a non-transitory computer-readable medium for cryptographic computation are provided. The method for computation includes: receiving, in a Montgomery multiplier circuit having a predefined block size, a pair of operands A and B and a modulus M for computation of a Montgomery product of A and B mod M; specifying a number n of blocks of the predefined block size to be used in the computation; computing a blinded modulus M′ as a multiple of the modulus M by a random factor R, M′=R*M, while selecting R so that the length of M′ is less than n times the block size by at least two bits; and operating the Montgomery multiplier circuit to compute and output the Montgomery product of A and B mod M′.

### CROSS-REFERENCE TO RELATED APPLICATION

This application claims the priority benefit of Israel application serial no. 239880, filed on Jul. 9, 2015. The entirety of the above-mentioned patent application is hereby incorporated by reference herein and made a part of this specification.

### BACKGROUND OF THE DISCLOSURE

Field of the Disclosure

The disclosure generally relates to a computation circuit and method thereof, and more particularly, to a computation circuit involving efficient modular multiplication.

Description of Related Art

There are many important cryptosystems, such as RSA and DSA, using modular arithmetic which includes exponentiation and multiplication with large modulus values. A classic method of computing a modular product involves first multiplying operand as non-modular integer and then obtaining a modulus of the result, which is referred to as modular reduction. However, the modular reduction is an expensive computation, which is equivalent to long division.

For such reason, it is not a common practice in cryptographic computations to use a more efficient method known as Montgomery modular multiplication (or simply Montgomery multiplication.) In order to perform the Montgomery modular multiplication, the operands are converted to a special Montgomery form using an algorithm known as Montgomery reduction. The multiplication of the operands in Montgomery form avoids the need for modular reduction as required in conventional arithmetic (although a simpler conditional reduction is still required if the resulting product is greater than the modulus.) The Montgomery reduction and multiplication algorithms are described, for example, by Menezes et al., in the Handbook of Applied Cryptography (1996), section 14.3.2, pages 600-603, which is incorporated herein by reference.

Blinding techniques are commonly applied in cryptographic operations in order to reduce vulnerability to attacks that attempt to extract secret values used in the computations. Various blinding techniques have been applied in modular computations, including Montgomery multiplications. For example, U.S. Pat. No. 8,422,671 describes a method in which a plurality of Montgomery multiplications are used in a modular exponentiation for decrypting a ciphertext using a secret key. The ciphertext is blinded by multiplying it with a random number, and the final value is multiplied by an inverse element to remove the blinding. U.S. Pat. No. 8,738,927 similarly describes a technique in which blinding is combined with Montgomery reduction.

Nothing herein should be construed as an admission of knowledge in the prior art of any portion of the present disclosure. Furthermore, citation or identification of any document in this application is not an admission that such document is available as prior art to the present disclosure, or that any reference forms a part of the common general knowledge in the art.

### SUMMARY OF THE DISCLOSURE

Embodiments of the present disclosure that are described herein below provide methods and apparatus that are useful in simplifying the performance of Montgomery multiplication while at the same time enhancing its resistance to attacks.

In an embodiment of the disclosure, a method for cyptographic computation, which includes receiving, in a Montgomery multiplier circuit having a predefined block size, a pair of operands A and B and a modulus M for computation of a Montgomery product of A and B mod M. A number n of blocks of the predefined block size is specified for use in the computation. A blinded modulus M′ is computed as a multiple of the modulus M by a random factor R, M′=R*M, while selecting R so that the length of M′ is less than n times the block size by at least two bits. The Montgomery multiplier circuit is operated to compute and output the Montgomery product of A and B mod M′.

Typically, operating the Montgomery multiplier circuit includes performing n iterations of a computational loop so as to generate a result equivalent to the Montgomery product of A and B mod M′ upon conclusion of the n iterations without performing a conditional modular reduction of the result. In some embodiments, the result is passed as an operand to the Montgomery multiplier circuit for a further operation without performing the conditional modular reduction.

In a disclosed embodiment, the method includes selecting at least one further random factor R′, and blinding at least one of the operands A and B by addition thereto of a blinding value R′*M, equal to a product of the at least one further random factor R′ with the modulus M.

In an embodiment of the disclosure, a cryptographic computational device, which includes inputs configured to receive a pair of operands A and B and a modulus M, and a Montgomery multiplier circuit, which has a predefined block size and is configured to receive as inputs the pair of operands A and B and the modulus M and to generate an output equal to a Montgomery product of A and B mod M, using a specified number n of blocks of the predefined block size in computation of the Montgomery product. The Montgomery multiplier circuit includes a multiplier, which is configured to compute a blinded modulus M′ as a product of the modulus M with a random factor R, M′=R*M, wherein R is selected so that the length of M′ is less than n times the block size by at least two bits, and the Montgomery multiplier circuit is operative to compute and output the Montgomery product of A and B mod M′.

In an embodiment of the disclosure, a non-transitory computer-readable medium, storing instructions, wherein the instructions, when read by a programmable processor having a predefined block size, cause the processor to receive a pair of operands A and B and a modulus M for computation of a Montgomery product of A and B mod M using a specified number n of blocks of the predefined block size, to calculate a blinded modulus M′ as a multiple of the modulus M by a random factor R, M′=R*M, while selecting R so that the length of M′ is less than n times the block size by at least two bits, and to compute and output the Montgomery product of A and B mod M′.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block diagram that schematically illustrates circuit elements in a cryptographic device, in accordance with an embodiment of the disclosure; and

FIG. 2 is a flow chart that schematically illustrates a method for modular multiplication, in accordance with an embodiment of the disclosure.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

Conventional Montgomery multiplication involves an iterative computation of a result over successive blocks of bits, followed by conditional reduction after computation of the most significant block. If the result is greater than the designated modulus M, it is reduced by subtraction of the modulus from the result. This conditional reduction adds to the complexity of the computation and also has been found to increase the vulnerability of the device performing the computation to side-channel attacks.

Embodiments of the present disclosure that are described herein provide improved Montgomery multiplication techniques, as well as devices implementing such techniques, that alleviate the need for the final step of conditional reduction. These techniques make use of blinding with a judiciously chosen random factor, and thus both enhance the security of computation and simplify the design of the multiplier.

In one of the exemplary embodiments of the disclosure, a Montgomery multiplier circuit has a predefined block size, for example, thirty-two bits, and receives as input a pair of operands A and B and a modulus M for computation of a Montgomery product of A and B mod M. The Montgomery multiplier circuit is configured to perform the computation over a specified number n of blocks of the predefined block size (i.e., using integers of length m=n*block size, or specifically m=32n bits in the present example). For purposes of blinding, the circuit computes a blinded modulus M′, which is a multiple of the specified modulus M by a random integer factor R, M′=R*M, and the computation is performed mod M′. The end result can be reduced to mod M in a straightforward manner and is unaffected by the use of the blinded modulus M′ in the intermediate computations.

Cryptographic computations generally are designed to make use of all available bits, in order to increase the difficulty of attack. In the present exemplary embodiments, however, the random factor R is selected for each computation so that the length of M′ is less than n times the block size by at least two bits. (Again, in the present example, this requirement means that the number of bits in M′ is no more than m−2=32n−2.) The Montgomery multiplier circuit then computes and outputs the Montgomery product of A and B mod M′. Specifically, the circuit performs n iterations of a computational loop so as to generate a result, upon conclusion of the n iterations, that is equivalent to the Montgomery product of A and B mod M. Given the appropriate choice of the random factor R to limit the length of M′, there is no need for a conditional modular reduction of the result.

More particularly, as long as the bit length of M′ is no greater than m−2, and the operands A and B have bit lengths no greater than m−1, it can be shown that:

1) The lengths of the intermediate computational results at each iteration of the computational loop will not exceed in; and

2) The probability that the length of the final result will exceed m−1 bits is negligibly small (probability less than 2⁻¹²⁸).

The first point above means that no more than m bits need be allocated in the circuit for storage of the intermediate computational results, and there is no need to check for and handle overflow bits in the computation. The second point means that the result of the computation can be fed back as an operand to the Montgomery multiplier circuit for a further computation without performing any sort of conditional modular reduction. This latter point is important, for example, in exponentiation operations, which require multiple successive multiplications.

The small probability that the final result will exceed m−1 bits is insignificant in practical applications of the disclosed techniques. Cryptographic systems are commonly designed to have a certain degree of tolerance to errors that may occur due to noise or even attempted fault injection attacks. On those rare occasions (with probability 2⁻¹²⁸) in which the simplified design of the Montgomery multiplier circuit that is described herein causes an apparent fault, the system will generally invoke a repeat computation. The repeat computation will be performed with a different random factor R, so that the probability of a repeated error is infinitesimal.

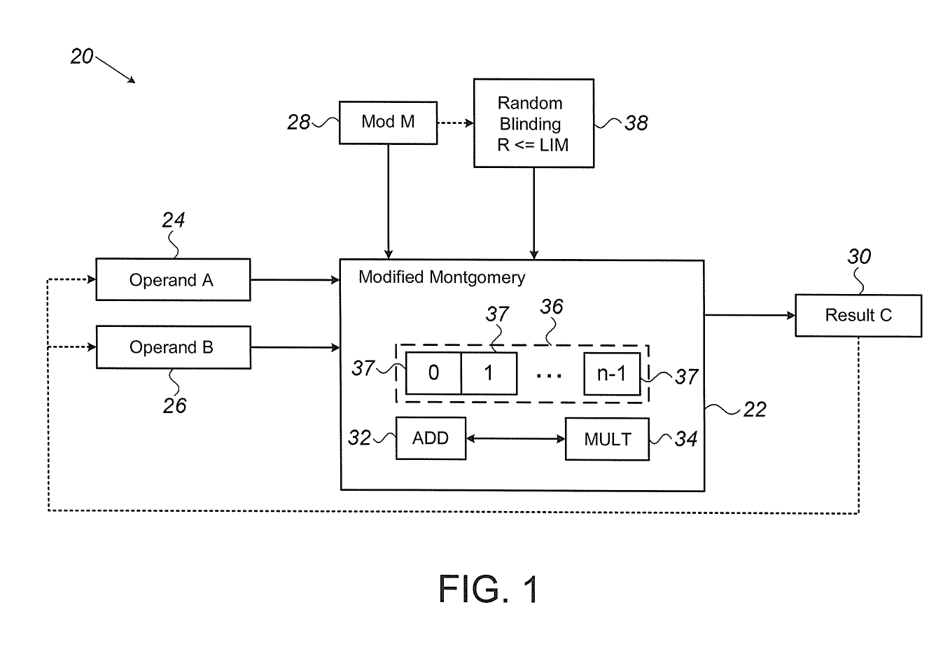

FIG. 1 is a block diagram that schematically illustrates circuit elements in a cryptographic device 20, in accordance with an embodiment of the disclosure. The circuit elements shown in the figure are typically implemented as hardware logic circuits in an integrated circuit (IC) device, but may alternatively be implemented in software on a suitable programmable processor. The pictured circuits carry out a Montgomery multiplication function that may be integrated into the cryptographic device in a wide variety of different configurations and applications, to perform operations connected with encryption, decryption, and/or authentication, for example. Only the elements of device 20 that are directly relevant to Montgomery multiplication are shown in the figure, and the integration of these elements with other components of device 20 will be apparent to those skilled in the art.

The device 20 comprises a Montgomery multiplier 22, which is modified, relative to multipliers that are known in the art, for the sort of simplified operation that is described above. Specifically, blinding of the modulus is applied in this embodiment with a random factor chosen such that conditional reduction of the result is not required.

The multiplier 22 has a pair of operand inputs 24, 26 (implemented as locations in a memory array, for example) to receive operands A and B, which may be of any length up to m−1 bits, as defined above, and a modulus input 28, which receives the value of the modulus M that is to be used in computing the Montgomery product A ⊙ B=A*B*2^{-m} % M. (The symbol “%” is used in the present description and in the figures to denote “modulo.”) Multiplier 22 outputs the result of the computation to an output 30 (such as another location in the memory array), whose contents may be delivered to other components of device 20 or fed back to one or both of inputs 24, 26 for subsequent computations, such as multiple, successive multiplications that are used in exponentiation.

The multiplier 22 comprises arithmetic circuits, including at least one adder 32 and at least one multiplier 34, with suitable interconnections for performing the iterative computations that are described herein below. The adder and multiplier typically operate on blocks of a predefined size, such as thirty-two bits. Multiplier 22 comprises one or more internal arrays 36 (possibly part of the same memory array as the inputs and outputs), to hold the blinded modulus M′ and intermediate computational values. Array 36 typically holds n blocks 37 of the specified block length, so that the total length of array 36 is m bits, wherein in the present example, m=32n, as noted above.

The multiplier 22 performs the computation of A ⊙ B using a blinded modulus M′=R*M, wherein R is a random number that is chosen by a random generator 38. The random generator is configured to limit R such that, given the value of M in modulus input 28, the product R*M will be no more than m−2 bits long. (In other words, at least the two most significant bits in the most significant block of M′ will be zero.) Random generator 38 may also generate one or more further random factors R′, which are used in blinding one or both of the operands A and B by addition thereto of blinding values of the form R′*M.

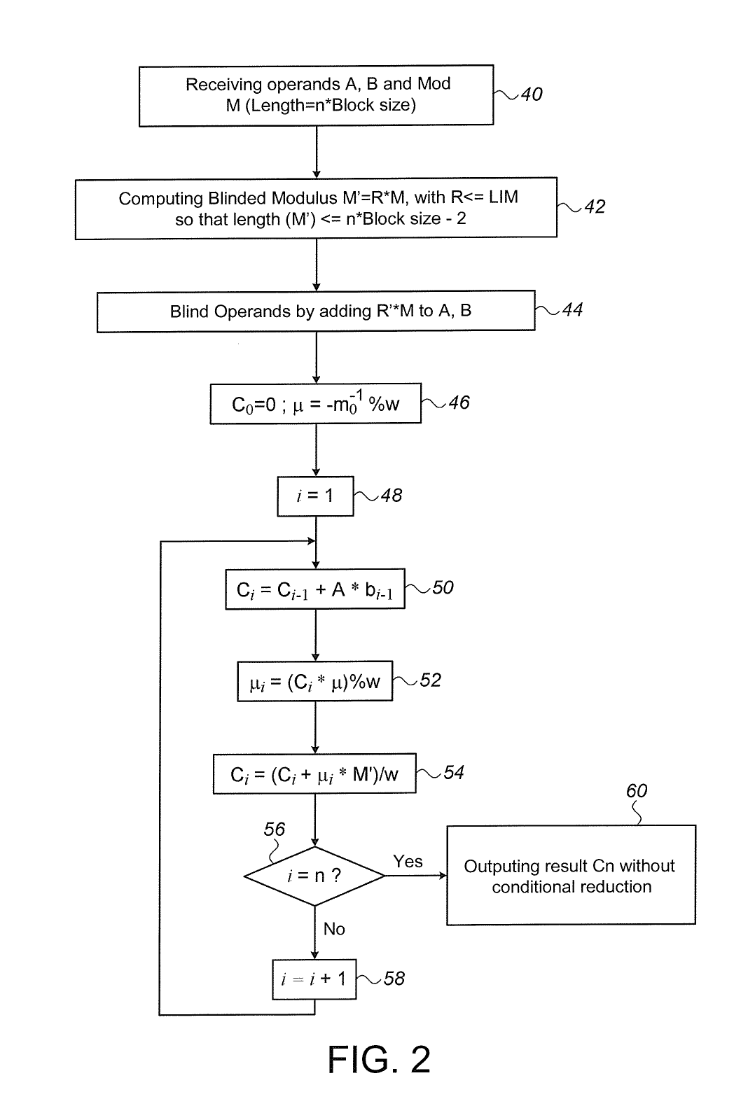

FIG. 2 is a flow chart that schematically illustrates a method for modular multiplication, in accordance with an embodiment of the disclosure. This method is described herein below, for the sake of clarity and convenience, with reference to the elements of device 20 that are shown in FIG. 1. Alternatively, the method may be carded out, mutatis mutandis, in other hardware configurations or in software, as noted above. All such alternative implementations are considered to be within the scope of the present disclosure.

Initially, multiplier 22 receives operands A and B and modulus M into inputs 24, 26 and 28, at an input step 40. The operands are integers of the form:

$$A = {a}_{n - 1} … {a}_{1} {a}_{0} = {\sum }_{i = 0}^{n - 1} {a}_{i} {w}^{i} , \\ B = {b}_{n - 1} {…b}_{1} {b}_{0} = {\sum }_{i = 0}^{n - 1} {b}_{i} {w}^{i}$$

wherein the coefficients aᵢ and bᵢ are blocks of bits of the specified block length (thirty-two bits in the present example), and w=2³². The modulus M is blinded by multiplication with a random value R, which is constrained to be no greater than an appropriate limit (depending on the value of M) so that the blinded value M′ contains no more than m−2 bits, at a modulus blinding step 42. The blinded modulus has the form:

M′=mₙ₋₁ . . . m₁m₀=Σᵢ₌₀ⁿ⁻ⁿmᵢwⁱ

wherein the coefficients mᵢ are likewise blocks of thirty-two bits.

Optionally, for further enhancement of the security of device 20, the operands A and B are blinded by addition thereto of respective values of the form R′*M, wherein R′ is some other random value, at an operand blinding step 44. The random values R′ are typically constrained so that the operands actually used in the multiplication are no more than m−1 bits long, i.e., at least the most significant bit of the operands is zero.

The multiplier 22 computes the product A ⊙ B by iterative operation over the blocks of the operands and intermediate results. To begin, a starting result parameter C0 and a modulus parameter μ are set to the values C₀=0; μ=−m₀⁻¹ % w, at a parameter setting step 46. The iteration index i is set to 1, at an initialization step 48. Multiplier 22 then performs the following steps in succession for each value of i=1 . . . , n:

Step 50: Cᵢ=C_{i -}+A*b_{i-1,}

Step 52: μᵢ=(Cᵢ*μ)% w,

Step 54: Cᵢ=(Cᵢ+μᵢ*M′)/w,

After each iteration, the multiplier checks the value of i, at step 56, and then increments i, at step 58, until the iterations are completed at i=n.

Upon completion of the iterations, multiplier 22 outputs the result C 32 Cn to output 30, at an output step 60. As explained above, no conditional reduction need be performed, and the length of the value C is, with high probability, no greater than m−1.

As noted earlier, in an alternative embodiment of the present disclosure, the steps and operations described above are carried out by a suitable programmable processor under the control of software program instructions. The software may be downloaded to the processor in electronic form, for example over a network. Additionally or alternatively, the software may be stored on tangible, non-transitory computer-readable media, such as optical, magnetic, or electronic memory media.

It will be appreciated that the embodiments described above are cited by way of example, and that the present disclosure is not limited to what has been particularly shown and described hereinabove. Rather, the scope of the present disclosure includes both combinations and subcombinations of the various features described hereinabove, as well as variations and modifications thereof which would occur to persons skilled in the art upon reading the foregoing description and which are not disclosed in the prior art.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A method for cryptographic computation, comprising:
receiving, in a Montgomery multiplier circuit having a predefined block size, a pair of operands A and B and a modulus M for computation of a Montgomery product of A and B mod M;
specifying a number n of blocks of the predefined block size to be used in the computation, wherein n is an integer greater than 1;
computing a blinded modulus M′ as a multiple of the modulus M by a random factor R, while selecting R so that the length of M′ is less than n times the block size by at least two bits; and
operating the Montgomery multiplier circuit to compute and output the Montgomery product of A and B mod M′.

2. The method according to claim 1, wherein operating the Montgomery multiplier circuit comprises performing n iterations of a computational loop so as to generate a result equivalent to the Montgomery product of A and B mod M upon conclusion of the n iterations without performing a conditional modular reduction of the result.

3. The method according to claim 2, further comprising:
feeding the result as an operand to the Montgomery multiplier circuit for a further operation without performing the conditional modular reduction.

4. The method according to claim 1, further comprising:
selecting at least one other random factor R′; and
blinding at least one of the operands A and B by addition thereto of a blinding value which equal to a product of the at least one other random factor R′ with the modulus M.

5. A device for cryptographic computation, comprising:
inputs configured to receive a pair of operands A and B and a modulus M; and
a Montgomery multiplier circuit, which has a predefined block size and is configured to receive as inputs the pair of operands A and B and the modulus M and to generate an output equal to a Montgomery product of A and B mod M, using a specified number n of blocks of the predefined block size in computation of the Montgomery product, wherein n is an integer greater than 1,
wherein the Montgomery multiplier circuit comprises a multiplier, which is configured to compute a blinded modulus M′ as a product of the modulus M with a random factor R, wherein R is selected so that the length of M′ is less than n times the block size by at least two bits, and the Montgomery multiplier circuit is operative to compute and output the Montgomery product of A and B mod M′.

6. The device according to claim 5, wherein the Montgomery multiplier circuit is configured to perform n iterations of a computational loop so as to generate a result equivalent to the Montgomery product of A and B mod M upon conclusion of the n iterations without performing a conditional modular reduction of the result.

7. The device according to claim 6, wherein the Montgomery multiplier circuit is configured to feed the result as an operand to at least one of the inputs for a further operation by the device, without performing the conditional modular reduction.

8. The device according to claim 5, wherein the Montgomery multiplier circuit is configured to blind at least one of the operands A and B by addition thereto of a blinding value which equal to a product of at least one further random factor R′ with the modulus M.

9. A non-transitory computer-readable medium, storing instructions, wherein the instructions, when read by a programmable processor having a predefined block size, cause the processor to receive a pair of operands A and B and a modulus M for computation of a Montgomery product of A and B mod M using a specified number n of blocks of the predefined block size, to calculate a blinded modulus M′ as a multiple of the modulus M by a random factor R, while selecting R so that the length of M′ is less than n times the block size by at least two bits, and to compute and output the Montgomery product of A and B mod M′, wherein n is an integer greater than 1.

10. The non-transitory computer-readable medium according to claim 9, wherein the instructions cause the processor to perform n iterations of a computational loop so as to generate a result equivalent to the Montgomery product of A and B mod M upon conclusion of the n iterations without performing a conditional modular reduction of the result.

11. The non-transitory computer-readable medium according to claim 10, wherein the instructions cause the processor to feed the result as an operand to a further Montgomery multiplication, without performing the conditional modular reduction.

12. The non-transitory computer-readable medium according to claim 9, wherein the instructions cause the processor to blind at least one of the operands A and B by addition thereto of a blinding value which equal to a product of at least one further random factor R′ with the modulus M.
